(19) United States
(12) Patent Application Publication
(10) Pub. No.: US 2026/0340810 A1
(43) Pub. Date: Oct. 29, 2026

(54) Noise Reduction with Multiple Modes

(71) Applicant: KLA Corporation, Milpitas, CA (US)

(72) Inventors: Hucheng LEE, Cupertino, CA (US); Hsiao-Min WANG, Taoyuan City (TW); CHEN-YI HUANG, Taoyuan City (TW); James A. SMITH, Los Altos, CA (US)

(21) Appl. No.: 19/646,258

(22) Filed: Apr. 13, 2026

Related U.S. Application Data
(60) Provisional application No. 63/795,640, filed on Apr. 28, 2025.

(51) Int. Cl. G06T 7/00; G06T 5/50; G06T 5/70

(52) U.S. Cl. CPC G06T 7/001; G06T 5/50; G06T 5/70; G06T 2207/20224; G06T 2207/30148

(57) ABSTRACT

Systems and methods for detecting defects on a reticle are provided. The systems are configured for generating different stacked difference images for multiple instances of a patterned area on a specimen from images generated with different modes of an inspection subsystem. One system averages the different stacked difference images from multiple modes to thereby generate an averaged stacked difference image and detects defect candidates in the multiple instances of the patterned area based on the averaged stacked difference image. Another system generates a two-dimensional scatter plot from the different stacked difference images from multiple modes and detects defect candidates in the multiple instances of the patterned area based on the two-dimensional scatter plot. The systems also identify defects on the reticle based on the detected defect candidates.

### BACKGROUND OF THE INVENTION

### 1. Field of the Invention

The present invention generally relates to systems and methods for repeater defect detection on print check wafers to detect defects on reticles with noise reduction in images via multiple modes.

### 2. Description of the Related Art

The following description and examples are not admitted to be prior art by virtue of their inclusion in this section.

Inspection processes are used at various steps during a semiconductor manufacturing process to detect defects on wafers to promote higher yield in the manufacturing process and thus higher profits. Some current inspection methods detect repeater defects on wafers to thereby detect defects on reticles. For example, if a defect is detected repeatedly (“a repeater defect”) at multiple locations on a wafer corresponding to the same location on a reticle, the defects may be caused by the reticle itself. Repeater defects may be analyzed to determine if they are caused by reticle defects, rather than some other cause.

In general, repeater defect detection (RDD) is performed as a wafer post-processing (PP) operation. For example, the inspection tool may perform normal die-to-die defect detection (DD) in a multi-die reticle case, and after all wafer defects are reported, the RDD may be performed in a post-processing step. The term “repeater defects” is defined herein as defects positioned at the same location (within a certain, predetermined tolerance) in several reticles.

There are, however, several disadvantages to the currently used methods and systems for RDD. For example, many currently used RDD methods and systems have been created to try to reduce noise so that repeater defects can be detected more accurately, with fewer detected nuisances, and with higher sensitivity. However, many attempts at wafer noise reduction are not capable of detecting smaller sizes of repeater defects required for next generation design rules. For example, for some relatively small/relatively weak repeaters (e.g., 5 nm to 8 nm in size or smaller) and relatively small/relatively weak random defects, currently used methods are not able to catch all of those defects due to noise not suppressed enough by using single mode images.

Accordingly, it would be advantageous to develop systems and methods for detecting repeater defects on a wafer and thereby defects on a reticle that do not have one or more of the disadvantages described above.

### SUMMARY OF THE INVENTION

The following description of various embodiments is not to be construed in any way as limiting the subject matter of the appended claims.

One embodiment relates to a system configured to detect defects on a reticle. The system includes an inspection subsystem configured to generate first and second images for a specimen with first and second modes, respectively, of the inspection subsystem. A reticle is used to print multiple instances of a patterned area on the specimen in a lithography process. The system also includes a computer subsystem configured for generating first and second stacked difference images for the multiple instances of the patterned area based on the first and second images, respectively, generated for the multiple instances of the patterned area. The computer subsystem is also configured for averaging the first and second stacked difference images to thereby generate an averaged stacked difference image and detecting defect candidates in the multiple instances of the patterned area on the specimen by applying a defect detection method to the averaged stacked difference image. The computer subsystem is further configured for identifying defects on the reticle based on the detected defect candidates. The system may be further configured as described herein.

Another embodiment relates to a computer-implemented method for detecting defects on a reticle. The method includes acquiring first and second images generated for a specimen with first and second modes, respectively, of an inspection subsystem. A reticle is used to print multiple instances of a patterned area on the specimen in a lithography process. The method also includes the generating, averaging, detecting, and identifying steps described above, which are performed by a computer subsystem coupled to the inspection subsystem.

Each of the steps of the method may be further performed as described herein. The method may include any other step(s) of any other method(s) described herein. The method may be performed by any of the systems described herein.

An additional embodiment relates to a non-transitory computer-readable medium storing program instructions executable on a computer system for performing a computer-implemented method for detecting defects on a reticle. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

A further embodiment relates to a system configured to detect defects on a reticle. The system includes an inspection subsystem configured to generate first and second images for a specimen with first and second modes, respectively, of the inspection subsystem. A reticle is used to print multiple instances of a patterned area on the specimen in a lithography process. The system also includes a computer subsystem configured for generating first and second stacked difference images for the multiple instances of the patterned area based on the first and second images, respectively, generated for the multiple instances of the patterned area. The computer subsystem is also configured for generating a two-dimensional (2D) scatter plot of second values in the second stacked difference images as a function of first values in the first stacked difference images corresponding to substantially the same locations in the multiple instances of the patterned area. In addition, the computer subsystem is configured for detecting defect candidates in the multiple instances of the patterned area on the specimen by applying a defect detection method to the 2D scatter plot. The computer subsystem is further configured for identifying defects on the reticle based on the detected defect candidates. The system may be further configured as described herein.

Yet another embodiment relates to a computer-implemented method for detecting defects on a reticle. The method includes acquiring first and second images generated for a specimen with first and second modes, respectively, of an inspection subsystem. A reticle is used to print multiple instances of a patterned area on the specimen in a lithography process. The method also includes the generating first and second stacked difference images, generating a 2D scatter plot, detecting, and identifying steps described above, which are performed by a computer subsystem coupled to the inspection subsystem.

Each of the steps of the method may be further performed as described herein. The method may include any other step(s) of any other method(s) described herein. The method may be performed by any of the systems described herein.

Another embodiment relates to a non-transitory computer-readable medium storing program instructions executable on a computer system for performing a computer-implemented method for detecting defects on a reticle. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 includes examples of stacked difference images generated by individual modes of an inspection subsystem;

FIG. 4 is an example of an averaged stacked difference image generated by an embodiment described herein;

FIG. 5 includes examples of two-dimensional (2D) scatter plots generated for individual modes of an inspection subsystem and an example of a 2D scatter plot generated from an averaged stacked difference image according to embodiments described herein;

FIG. 6 is an example of a 2D scatter plot generated from stacked difference images generated for different modes of an inspection subsystem according to embodiments described herein; and

FIG. 7 is a block diagram illustrating one embodiment of a non-transitory computer-readable medium storing program instructions executed on a computer system for performing one or more of the computer-implemented methods described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured to detect defects on a reticle. The embodiments described herein provide new and improved methods and systems for substantially high sensitivity repeater defect detection (RDD) for detection of mask defects by inspection of a specimen printed with the mask. The terms “reticle” and “mask” are used interchangeably herein. The term “repeaters” is used interchangeably herein with the term “repeater defects.”

The terms “first” and “second” are used herein only to differentiate between different things, e.g., different images, different modes, etc. These terms are not meant to indicate any other preferential, spatial, temporal, or other characteristics of the elements. In addition, although some embodiments may be described with respect to first and second elements, like first and second images, the embodiments are not limited to only two of any one element. For example, although some embodiments may be described with respect to first and second images, they may also be performed for third and fourth images and so on.

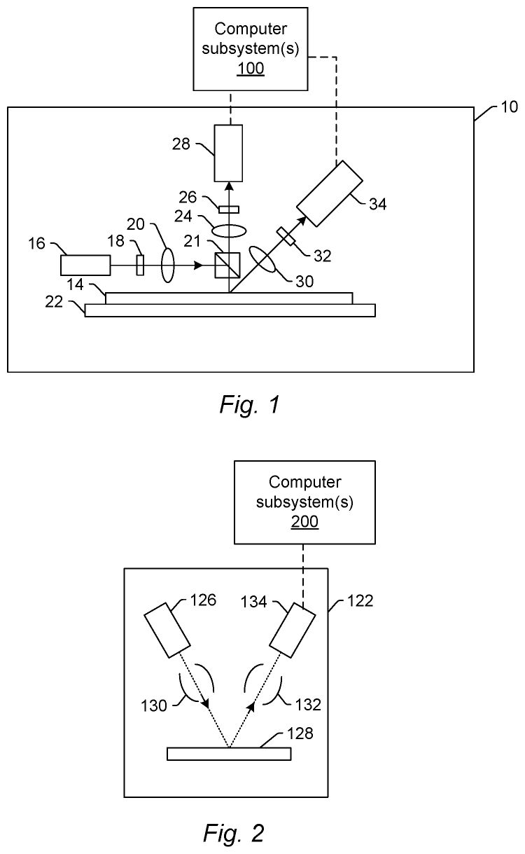

One embodiment of such a system configured to detect defects on a reticle is shown in FIG. 1. The system includes an inspection subsystem configured to generate first and second images for a specimen with first and second modes, respectively. The inspection subsystems described herein may include at least an energy source and a detector. The energy source is configured to generate energy that is directed to a specimen. The detector is configured to detect energy from the specimen and to generate output (e.g., images) responsive to the detected energy.

In one embodiment, the energy directed to the specimen includes light, and the energy detected from the specimen includes light. For example, in the embodiment of the system shown in FIG. 1, inspection subsystem 10 includes an illumination subsystem configured to direct light to specimen 14. The illumination subsystem includes at least one light source, e.g., light source 16. In one embodiment, the illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to beam splitter 21, which directs the light to specimen 14 at a normal angle of incidence. The angle of incidence may include any suitable angle of incidence, which may vary depending on, for instance, characteristics of the specimen and the defects to be detected on the specimen.

The illumination subsystem may be configured to direct the light to the specimen at different angles of incidence at different times. For example, the inspection subsystem may be configured to alter one or more characteristics of one or more elements of the illumination subsystem such that the light can be directed to the specimen at an angle of incidence that is different than that shown in FIG. 1. In one such example, the inspection subsystem may be configured to move light source 16, optical element 18, and lens 20 such that the light is directed to the specimen at a different angle of incidence.

In some instances, the inspection subsystem may be configured to direct light to the specimen at more than one angle of incidence at the same time. For example, the illumination subsystem may include more than one illumination channel, one of the illumination channels may include light source 16, optical element 18, and lens 20 as shown in FIG. 1 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the illumination subsystem may include only one light source (e.g., source 16 shown in FIG. 1) and light from the light source may be separated into different optical paths (e.g., based on wavelength, polarization, etc.) by one or more optical elements (not shown) of the illumination subsystem. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, in some instances, optical element 18 may be configured as a spectral filter and the properties of the spectral filter can be changed in a variety of different ways (e.g., by swapping out the spectral filter) such that different wavelengths of light can be directed to the specimen at different times. The illumination subsystem may have any other suitable configuration known in the art for directing the light having different or the same characteristics to the specimen at different or the same angles of incidence sequentially or simultaneously.

In one embodiment, light source 16 may include a broadband plasma (BBP) light source. In this manner, the light generated by the light source and directed to the specimen may include broadband light. However, the light source may include any other suitable light source such as any suitable laser known in the art and may be configured to generate light at any suitable wavelength(s) known in the art. In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused to beam splitter 21 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for inspection.

The inspection subsystem may also include a scanning subsystem configured to cause the light to be scanned over the specimen. For example, the inspection subsystem may include stage 22 on which specimen 14 is disposed during inspection. The scanning subsystem may include any suitable mechanical and/or robotic assembly (that includes stage 22) that can be configured to move the specimen such that the light can be scanned over the specimen. In addition, or alternatively, the inspection subsystem may be configured such that one or more optical elements of the inspection subsystem perform some scanning of the light over the specimen. The light may be scanned over the specimen in any suitable fashion.

The inspection subsystem further includes one or more detection channels. At least one of the one or more detection channels includes a detector configured to detect light from the specimen due to illumination of the specimen by the inspection subsystem and to generate output responsive to the detected light. For example, the inspection subsystem shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, one detection channel is configured to detect specularly reflected light, and the other detection channel is configured to detect light that is not specularly reflected (e.g., scattered, diffracted, etc.) from the specimen. However, two or more of the detection channels may be configured to detect the same type of light from the specimen (e.g., specularly reflected light). Although FIG. 1 shows an embodiment of the inspection subsystem that includes two detection channels, the inspection subsystem may include a different number of detection channels (e.g., only one detection channel or two or more detection channels). Although each of the collectors are shown in FIG. 1 as single refractive optical elements, each of the collectors may include one or more refractive optical element(s) and/or one or more reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the inspection subsystem may be signals or data, but not image signals or image data. In such instances, a computer subsystem described further herein may be configured to generate images of the specimen from the non-imaging output of the detectors. In other instances, the detectors may be configured as imaging detectors that are configured to generate image signals or image data. Therefore, the system may be configured to generate the images described herein in a number of ways.

Computer subsystem(s) 100 of the system may be coupled to the detectors of the inspection subsystem in any suitable manner (e.g., via one or more transmission media, which may include “wired” and/or “wireless” transmission media) such that the computer subsystem(s) can receive the output generated by the detectors during scanning of the specimen. Computer subsystem(s) 100 may be configured to perform a number of functions using the output of the detectors as described herein and any other functions described further herein. Computer subsystem(s) 100 may be further configured as described herein.

Computer subsystem(s) 100 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device, adapted according to the various embodiments described herein. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and SW, either as a standalone or a networked tool.

If the system includes more than one computer subsystem, the computer subsystems may be coupled to each other such that images, data, information, instructions, etc. can be sent between the various computer subsystems. For example, different computer subsystems may be coupled to each other by any suitable transmission media, which may include any suitable wired and/or wireless transmission media known in the art. Two or more of the computer subsystems may also be effectively coupled by a shared computer-readable and -writable storage medium (not shown).

Although the inspection subsystem is described above as being an optical or light-based inspection subsystem, the inspection subsystem may be an electron beam-based inspection subsystem. For example, in one embodiment, the energy directed to the specimen includes electrons, and the energy detected from the specimen includes electrons. In this manner, the energy source may be an electron beam source. In one such embodiment shown in FIG. 2, the inspection subsystem includes electron column 122, which is coupled to computer subsystem(s) 200.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Mar. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam-based subsystem may be configured to use multiple modes to generate images of the specimen (e.g., with different illumination angles, collection angles, etc.). The multiple modes of the electron beam-based subsystem may be different in any image generation parameters of the subsystem.

Computer subsystem(s) 200 may be coupled to detector 134 as described above. The detector may detect electrons returned from the surface of the specimen thereby forming electron beam images of the specimen. The electron beam images may include any suitable electron beam images. Computer subsystem(s) 200 may be configured to perform any of the functions described herein using the output of the detector and/or the electron beam images. Computer subsystem(s) 200 may be configured to perform any additional step(s) described herein. A system that includes the inspection subsystem shown in FIG. 2 may be further configured as described herein.

FIGS. 1 and 2 are provided herein to generally illustrate configurations of an inspection subsystem that may be included in the system embodiments described herein. Obviously, the inspection subsystem configurations described herein may be altered to optimize the performance of the system as is normally performed when designing a commercial inspection system. In addition, the systems described herein may be implemented using an existing inspection system (e.g., by adding functionality described herein to an existing inspection system) such as the 29xx/39xx series of tools that are commercially available from KLA Corp., Milpitas, Calif. For some such systems, the methods described herein may be provided as optional functionality of the system (e.g., in addition to other functionality of the system). Alternatively, the system described herein may be designed “from scratch” to provide a completely new system.

Although the inspection subsystem is described above as being a light-or electron beam-based inspection subsystem, the inspection subsystem may be an ion beam-based inspection subsystem. Such an inspection subsystem may be configured as shown in FIG. 2 except that the electron beam source may be replaced with any suitable ion beam source known in the art. In addition, the inspection subsystem may be any other suitable ion beam-based subsystem such as those included in commercially available focused ion beam (FIB) systems, helium ion microscopy (HIM) systems, and secondary ion mass spectroscopy (SIMS) systems.

As noted above, the inspection subsystems may be configured for directing energy (e.g., light, electrons) to and/or scanning energy over a physical version of the specimen thereby generating actual images for the physical version of the specimen. In this manner, the inspection subsystems may be configured as “actual” imaging systems, rather than “virtual” systems. A storage medium (not shown) and computer subsystem(s) 100 shown in FIG. 1 may be configured as a “virtual” system. Systems and methods configured as “virtual” inspection systems are described in commonly assigned U.S. Pat. No. 8,126,255 issued on Feb. 28, 2012 to Bhaskar et al. and U.S. Pat. No. 9,222,895 issued on Dec. 29, 2015 to Duffy et al., both of which are incorporated by reference as if fully set forth herein. The embodiments described herein may be further configured as described in these patents.

As further noted above, the inspection subsystem may be configured to have multiple modes. In general, a “mode” is defined by the values of parameters of the inspection subsystem used to generate output for the specimen. Therefore, modes that are different may be different in the values for at least one of the optical or electron beam parameters of the inspection subsystem (other than position on the specimen at which the output or images are generated). For example, for a light-based inspection subsystem, different modes may use different wavelengths of light. The modes may be different in the wavelengths of light directed to the specimen as described further herein (e.g., by using different light sources, different spectral filters, etc.) for different modes. In another embodiment, different modes may use different illumination channels. For example, as noted above, the inspection subsystem may include more than one illumination channel. As such, different illumination channels may be used for different modes. In another example that may be particularly suitable for the embodiments described herein, two scans of the specimen may be performed by the inspection subsystem with two different illumination polarizations separately, which can increase the number of potential repeaters that are caught by the embodiments described herein.

The multiple modes may also be different in illumination and/or collection/detection. For example, as described further above, the inspection subsystem may include multiple detectors. One of the detectors may be used for one mode, and another of the detectors may be used for another mode. Furthermore, the modes may be different from each other in more than one way described herein (e.g., different modes may have one or more different illumination parameters and one or more different detection parameters). The inspection subsystem may be configured to scan the specimen with the different modes in the same scan or different scans, e.g., depending on the capability of using multiple modes to scan the specimen at the same time.

A reticle is used to print multiple instances of a patterned area on a specimen in a lithography process. The lithography process may include any suitable lithography process. In general, a lithography process uses some form of energy (e.g., light, electrons, etc.) to transfer a pattern formed on a reticle to a material on a specimen. The specimen in this case is usually a wafer of some sort, but the specimens described herein may include any specimen that can be patterned by a reticle in a lithography process. The material on the specimen may be some form of resist, one or more properties of which change after exposure to the energy used in the lithography process. In this manner, a pattern of energy (light, electrons, etc.) can be directed from or through a reticle to a resist on a specimen to thereby transfer the pattern from the reticle to the resist. One or more additional steps may be performed on the resist (e.g., post exposure bake, development, etc.) to complete the pattern transfer process.

As can be clearly seen from this general description of lithography processes, therefore, defects that are present on a reticle can be transferred to a specimen in the lithography process, which is obviously disadvantageous. Sometimes it is not possible or practical to inspect a reticle directly, as in a reticle inspection process. In such instances, the reticle is printed on a specimen, the specimen is inspected for defects, and those specimen defects are used to determine if the defects are caused by the reticle. Such determinations may be performed as described further herein.

The reticles described herein may include any reticle whose potential defectivity is of interest. Examples of some reticles that may be inspected as described herein, include single die reticles (SDRs) and multiple die reticles (MDRs). An SDR reticle is a mask that contains only one die, and an MDR reticle is a mask that contains several identical dies. The reticle may also be configured for use at an extreme ultraviolet (EUV) wavelength. Such a mask may then be referred to as an EUV mask. In other words, the mask may be configured for use in a lithography process that uses one or more EUV wavelengths of light to transfer the pattern from the mask to a specimen (e.g., by reflecting the EUV light off the mask to the specimen). In this manner, the actinic wavelength of the mask (i.e., the wavelength of light that is used to transfer a pattern from the mask to a specimen thereby causing a photochemical reaction in one or more materials on the wafer, e.g., a photoresist) may be an EUV wavelength. Although the embodiments described herein are particularly useful for defect detection on EUV masks, the embodiments may also be used for defect detection on other types of SDR and MDR such as masks designed for use at one or more deep ultraviolet (DUV) wavelengths of light (i.e., single-or multi-die, optical or DUV masks).

The embodiments described herein provide substantially high sensitivity repeater defect detection (RDD) for print check type inspections. “Print check” is defined herein as a type of mask inspection that involves printing the mask on a specimen, inspecting the specimen, and identifying defects on the mask based on the specimen inspection results. Print check may be used for a variety of applications including identifying reticle repeaters for mask qualification and/or monitoring, which may be performed to routinely or regularly check masks released to production for possible contamination. Print check can be used for both SDR and MDR.

The patterned area, multiple instances of which are printed on the specimen in the lithography process, may include any patterned area printed on the specimen corresponding to the same area on the reticle. In general, each instance of a patterned area printed on the specimen and corresponding to the same area on the reticle may be a whole die or a portion of a die. In the same manner, each instance of a patterned area printed on a specimen may be another type of patterned area on the reticle repeatedly printed on the specimen such as a field. Multiple instances of a patterned area printed on the specimen in the lithography process, therefore, refers to any repeating area printed on the specimen with the same portion of the reticle. In this manner, at least some of the images generated by the inspection subsystem correspond to different instances of the same area on the reticle printed on the wafer. Although the embodiments are described herein with respect to multiple instances of a patterned area on the specimen corresponding to the same patterned area on a reticle (i.e., multiple instances of one patterned area), the embodiments described herein may also be separately performed for multiple instances of a different patterned area on the specimen corresponding to another patterned area on the reticle. For example, the embodiments described herein may be separately performed for different portions of multiple instances of a die printed on the specimen with the reticle, which may sometimes be done for practical reasons.

The system also includes a computer subsystem configured for generating first and second stacked difference images for the multiple instances of the patterned area based on the first and second images, respectively, generated for the multiple instances of the patterned areas. In other words, the computer subsystem may generate a first stacked difference image for the multiple instances of the patterned area from the first images generated with the first mode and a second stacked difference image for the multiple instances of the patterned area from the second images generated with the second mode. Generating first and second stacked difference images as described herein reduces a considerable amount of noise in the stacked difference images compared to the individual difference images, which can increase the number of repeaters that can be detected by the embodiments described herein.

In one embodiment, generating the first stacked difference image includes generating first difference images for the multiple instances of the patterned area and combining at least a portion of the first difference images, and generating the second stacked difference image includes generated second difference images for the multiple instances of the patterned area and combining at least a portion of the second difference images. The first and second difference images may be generated as described further herein. Combining at least a portion of the first difference images may include aligning multiple first difference images in some manner and then averaging the signals at each corresponding location in the first difference images. The first stacked difference image may then include the averaged signals at each of the corresponding locations. The second stacked difference image may be generated in the same manner. As such, different stacked difference images may be generated for different modes of the inspection subsystem, which provides advantages as described further herein.

In one such embodiment, generating the first difference images includes separately subtracting a first reference from the first images, and generating the second difference images includes separately subtracting a second reference from the second images. The first and second references may be generated or acquired in any suitable manner. For example, the references may be computed references (CRs), which can reduce a considerable amount of noise in the difference images compared to die-to-die difference image generation. The CRs may be generated in any suitable manner known in the art. Some examples of methods and systems for generating CRs are described in commonly owned U.S. Patent Application Publication No. 2024/0054632 by Yu et al. published Feb. 15, 2024, which is incorporated by reference as if fully set forth herein. The embodiments described herein may be further configured as described in this publication.

The computer subsystem is also configured for averaging the first and second stacked difference images to thereby generate an averaged stacked difference image. For example, the embodiments described herein can reduce specimen noise by averaging stacked difference images generated with different modes of the inspection subsystem. This idea can be applied to repeater detection and random defect detection. Averaging the first and second stacked difference images may be performed in any suitable manner known in the art. For example, the first and second stacked difference images may be aligned to each other in any suitable manner. For corresponding locations (e.g., pixels) in the different stacked difference images, the signals may be averaged and the averaged signals as a function of location may be used to generate the averaged stacked difference image.

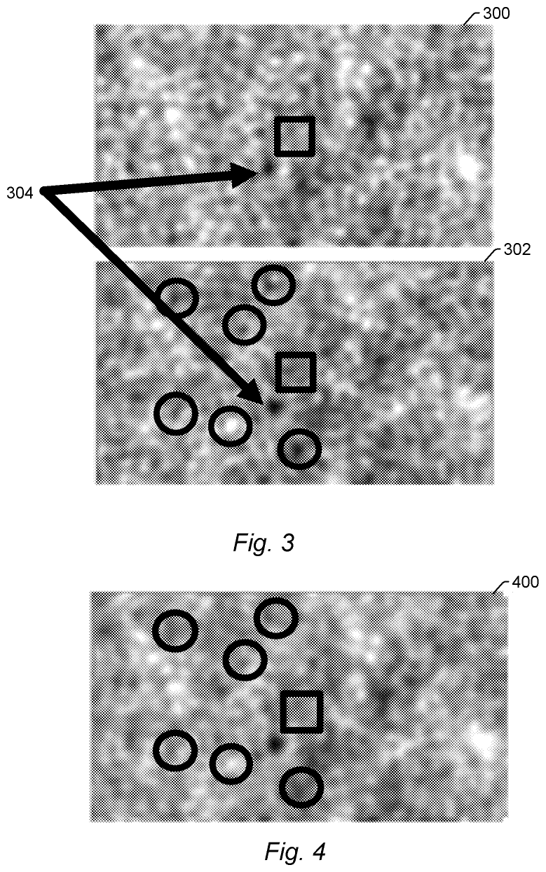

In one embodiment, noise in the first and second stacked difference images is not correlated. For example, by generating stacked difference images with different modes separately, the inventors have observed that specimen noise from different modes is not correlated. FIG. 3 shows some examples of stacked difference images generated by different modes. Image 300 is a stacked difference image generated by mode 1, and image 302 is a stacked difference image generated by mode 2. Noise is not correlated between different modes as shown by the circled locations in image 302. In other words, relatively strong noise signals that are present in image 302 and shown by the circled areas in the image do not have correlating noise signals at substantially the same locations in image 300 as shown by the absence of the circled locations.

In another embodiment, noise in the averaged stacked difference image is suppressed compared to the noise in the first and second stacked difference images. In particular, since noise is not correlated in the stacked difference images from different modes as described above, averaging stacked difference images generated by different modes helps suppress wafer noise, as shown in averaged stacked difference image 400 in FIG. 4. More specifically, image 400 has less noise at the circled locations in this image than at corresponding locations in stacked difference images 300 and 302 shown in FIG. 3. Therefore, by averaging stacked difference images from different modes, wafer noise may be further reduced at the circled locations compared to the stacked difference images.

In an additional embodiment, a signal corresponding to at least one of the defect candidates in the first and second stacked difference images is correlated. For example, by generating stacked difference images with different modes separately, the inventors have also observed that signals from defects of interest (DOIs) are correlated. As shown in FIG. 3, DOI signals 304 at corresponding locations in stacked difference images 300 and 302 are correlated. Since the DOI signals are correlated in the stacked difference images, these signals will be retained in the averaged stacked difference image.

In a further embodiment, the defect candidates have a higher signal-to-noise ratio (SNR) in the averaged stacked difference image than in the first and second stacked difference images. For example, by suppressing noise in the averaged stacked difference image while retaining signals from DOI, the DOI SNR in the averaged stacked difference image will be higher than in the first and second stacked difference images. Therefore, as described further herein, the embodiments provide a new noise reduction method, which utilizes non-correlated noise behavior and correlated signal from DOI from different modes to reduce wafer noise and boost DOI detection. In other words, as noise is reduced by the embodiments described herein, the embodiments are able to catch more relatively small/relatively weak repeaters and random defects compared to currently used methods.

The computer subsystem is further configured for detecting defect candidates in the multiple instances of the patterned area on the specimen by applying a defect detection method to the averaged stacked difference image. In general, any defect detection method may be used in the embodiments described herein. For example, the averaged stacked difference image may be input to a defect detection method in the same manner as any other image generated for inspection.

Examples of suitable defect detection methods that can be used in the detecting steps described herein include the multi-die auto-thresholding (MDAT) algorithm that is used by some inspection systems commercially available from KLA. In the most general sense, this algorithm may generate a 2D scatter plot of different values in an image input to the defect detection algorithm, define a noise cloud in the 2D scatter plot based on some threshold(s) applied to the 2D scatter plot, and detect any data points outside of the noise cloud (i.e., outliers) as potential defect candidates. While this is a relatively simplistic description of how the MDAT algorithm may function, various parameters of the algorithm can be modified for different applications, which can provide more sophisticated or tailored solutions for more difficult or complicated inspections. Additional description of some implementations of the MDAT algorithm can be found in commonly owned U.S. Pat. No. 9,619,876 to Huang et al. issued Apr. 11, 2017, which is incorporated by reference as if fully set forth herein. The embodiments described herein may be further configured as described in this patent.

In one embodiment, the detected defect candidates include a DOI that is not detectable in the first and second images and the first and second stacked difference images. For example, as described further herein, detecting defect candidates with the averaged stacked difference image is advantageous since it will have a higher SNR for DOIs and defect candidates more generally. Therefore, the defect candidates that are detected in the averaged stacked difference image may include DOIs that are not detectable in any of the first and second images, the first and second difference images, and the first and second stacked difference images. In this manner, the embodiments described herein may generate DOI detection results with improved quality.

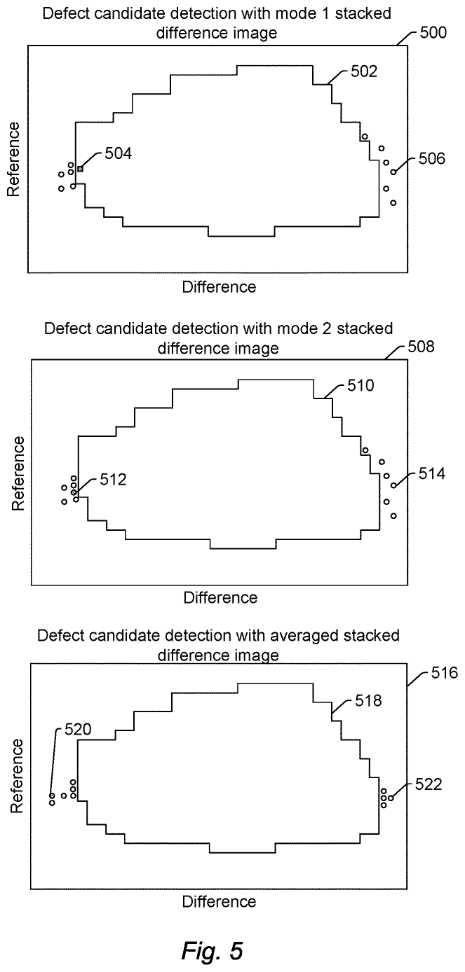

FIG. 5 illustrates examples of some results that may be generated by the detecting defect candidates step that illustrate how a DOI that is not detectable in stacked difference images generated for different modes becomes detectable in a multi-mode averaged stacked difference image. 2D scatter plot 500 may be generated for defect candidate detection with a mode 1 stacked difference image, 2D scatter plot 508 may be generated for defect candidate detection with a mode 2 stacked difference image, and 2D scatter plot 516 may be generated for defect candidate detection with an averaged stacked difference image. As shown in FIG. 5, each of the 2D scatter plots were generated from a value (e.g., SNR) in a reference image (used to generate its corresponding stacked difference image) as a function of a value (e.g., SNR) in a difference image, at corresponding locations in the reference and difference images. The 2D scatter plots may be generated from other values and images as described further herein.

Defect detection performed with each of the scatter plots shown in FIG. 5 identifies a noise cloud and data points outlying the noise cloud as described further above. For example, in 2D scatter plot 500 generated for mode 1, noise cloud 502 is identified with outlying data points 506 (all of the circled points) detected as potential defect candidates. In 2D scatter plot 508 generated for mode 2, noise cloud 510 is identified with outlying data points 514 (all of the circled points) detected as potential defect candidates. In 2D scatter plot 516 generated from the averaged stacked difference image (and therefore generated for multiple modes), noise cloud 518 is identified with outlying data points 522 (all of the circled points) detected as potential defect candidates.

Although not shown in FIG. 5, each of the noise clouds may also include actual data points, which are not shown here for the sake of clarity. In addition, although each of the noise clouds are shown in FIG. 5 as having the same shape and shape only for the sake of simplicity, each of the noise clouds may in fact have substantially different shapes and sizes, which are determined by the data point values themselves. For example, since the averaged stacked difference image contains less noise than both of the stacked difference images from which it is generated, the noise cloud in the 2D scatter plot generated from the averaged stacked difference image will generally be narrower due to the lower noise level. In other words, the noise cloud in multi-mode 2D scatter plot 516 will shrink on the x-axis. In one such non-limiting example, the range of noise in the 2D scatter plot generated for the first mode stacked difference image may be (−68, 72) on the x-axis, the range of noise in the 2D scatter plot generated for the second mode stacked difference image may be (−72, 72) on the x-axis, and the range of noise in the 2D scatter plot generated for the multi-mode averaged stacked difference image may be (−60, 60) on the x-axis. Therefore, the noise cloud for the multi-mode averaged stacked difference image may be narrower than both of the noise clouds generated from the first and second stacked difference images.

As a result of the noise suppression, a defect signal at corresponding locations in the different images, used to generate the different 2D scatter plots shown in FIG. 5, will stand out more from the noise cloud in 2D scatter plot 516 compared to 2D scatter plots 500 and 508. In particular, data point 504 in 2D scatter plot 500, data point 512 in 2D scatter plot 508, and data point 520 in 2D scatter plot 516 illustrate examples of signals corresponding to a location of a defect in each of the different images used to generate the 2D scatter plots. As shown in 2D scatter plot 500, data point 504 for the defect is actually located within noise cloud 502. The defect will not therefore be detectable in that 2D scatter plot. As shown in 2D scatter plot 508, data point 512 for the defect is located outside, but substantially close to, the boundary of noise cloud 510 and therefore, although technically outside of the noise cloud, will be indistinguishable from non-defect signals corresponding to data points 514 that are also outside of the noise cloud. Nuisance filtering may or may not be able to separate the defect signal from the other outliers detected in that 2D scatter plot.

As shown in 2D scatter plot 516, however, data point 520 for the defect is located farther outside of noise cloud 518 than in either of the other 2D scatter plots. Therefore, the defect is more detectable in 2D scatter plot 516 generated from the averaged stacked difference image than in the 2D scatter plots generated from the stacked difference images generated for the individual modes. In this manner, the defect candidates detected by the embodiments described herein may include DOI(s) that are not detectable in the first and second images and the first and second stacked difference images. While data point 520 for the defect may not be completely separated from other outliers in 2D scatter plot 516, data point 520 has better separation from more of the other outlying data points than in 2D scatter plot 508.

In one embodiment, the defect detection method determines that a defect candidate is present at a location in the multiple instances of the patterned area only when the defect detection method detects the defect candidate at the location in the averaged stacked difference image. In other words, the defect detection method is not applied to the different stacked difference images, the individual difference images, or the images themselves. Instead, the only inspection subsystem image-based input to the defect detection method or algorithm may be the averaged stacked difference image. Using the averaged stacked difference image as the only inspection subsystem image-based input to the defect detection method may be advantageous (even if the other images described herein are available as inputs to the defect detection method) since the averaged stacked difference image will have less noise than each of the other images and a higher SNR for any DOIs present in the images. Therefore, other images described herein will generally provide no information, signals, etc. that can enhance repeater defect detection performed with only the averaged stacked difference image. Of course, the input to the defect detection method may include other images like reference image(s) for one or more of the modes, design information for the specimen, care area (CA) information for the specimen, and the like that can be used with the averaged stacked difference image to detect defect candidates on the specimen.

The output of the detection step may be defect detection results having any suitable form or format, e.g., in which a location of any defect candidate detected in the averaged stacked difference image is identified in one or more of the averaged stacked difference image, the first and second stacked difference images, the first and second difference images, the first and second images, etc. with some sort of indicia (such as an asterisk). In addition, the output of the detection step may include any other information normally included in a lot result file generated by inspection systems such as those described herein.

The computer subsystem is also configured for identifying defects on the reticle based on the detected defect candidates. As described further herein, when a defect candidate is detected in the averaged stacked difference image, a defect candidate may be initially identified in each of the stacked difference images, difference images, or first and second images for which the detection was performed. However, a defect may not actually be located at the defect candidate location in each instance of the patterned area for which the detection was performed. The computer subsystem may perform one or more steps to first determine if a defect is located at the defect candidate location in each of the first and/or second images and to then determine if the defect sufficiently repeats in multiple instances of a patterned area to be considered a reticle defect based on the number of first and/or second images. These steps may be performed as described further herein based at least partially on some characteristic of the first and/or second images at the locations of the detected defect candidates.

In one embodiment, the defects identified on the reticle include at least one defect on the reticle that prints in two or more of the multiple instances of the patterned area on the specimen. For example, due to the nature of the defect detection performed as described herein, defects that repeat in two or more instances of the patterned area on the specimen will have a boosted SNR in the averaged stacked difference image compared to the other images described herein due to the noise suppression of the embodiments described herein. Therefore, generally, defects that do not repeat in multiple instances of the patterned area will not be detected by the embodiments described herein. Primarily detecting defects that repeat in multiple instances of the patterned area will be advantageous for the embodiments described herein and detecting defects on reticles, which generally will repeat in the patterned areas on the specimen. For example, detecting primarily repeater defects on the specimen will reduce the number of defect candidates that are detected and then processed to identify defects on the reticle. While there may also be defects on the specimen that do not repeat in multiple instances of the patterned area and/or are not due to the reticle itself, those defects may not be of interest for the instances in which the embodiments described herein are used.

If non-repeating defects are also of interest, however, another type of defect detection may be performed with the same first and second images described herein to detect those defects. For example, the same images that are used as described herein for repeater defect detection intended for detection of reticle defects may also be used for detecting other defects on the specimen and/or the reticle. In one such embodiment, defect detection may be also performed separately with the images, difference images, stacked difference images, etc. generated by a single mode of the inspection subsystem. Such defect detection may be performed as described herein or in any other manner known in the art. In addition, different defect detections may be performed separately with any of the images generated for any individual modes of the inspection subsystem, i.e., a first defect detection with only mode 1 images, a second defect detection with only mode 2 images, and so on. These defect detections may be performed for detecting random, i.e., non-repeating, defects on the specimen, which may have a cause other than the reticle used to print the specimen. Information for these defects may, however, be used with information for the detected defect candidates, which may be due to reticle defects, to determine information for the specimen, the lithography process, and any other process, step, material, etc. involved in the printing of the reticle on the specimen.

In some embodiments, identifying the defects on the reticle includes determining an image characteristic at the location of a detected defect candidate in two or more of the first and/or second images and/or the first and/or second difference images of the multiple instances of the patterned area, comparing the determined image characteristic to a threshold, determining a number of the images of the multiple instances of the patterned area having the determined image characteristic above the threshold, and comparing the determined number to a repeater threshold.

In one such embodiment, the defect detection results generated by the detecting defect candidates step may be input to the identifying step. The computer subsystem may calculate a local SNR for each defect candidate location in two or more of the first and/or second images and/or first and/or second difference images. Although some embodiments may be described herein with respect to a local SNR, the embodiments may use any other suitable local image characteristic or metric for this step including, but not limited to, magnitude, spot likeness, local salience, energy parameter, repeater signal, etc. Any of these local image characteristics may be determined in any suitable manner known in the art.

The computer subsystem may compare the determined local image characteristic at the location in each of the two or more images to a threshold (essentially a repeater defect detection threshold). The results of this step may include any suitable indicia such as an asterisk that indicates that the defect candidate location in a first and/or second image and/or first and/or second difference image has a local image characteristic above the threshold, and a different indicia such as a degree symbol that indicates that the defect candidate location in a first and/or second image and/or first and/or second difference image has the local image characteristic below the threshold.

The computer subsystem may also perform nuisance filtering by local image characteristic thereby producing defect detection results. In one such example, nuisance filtering may include eliminating any defect candidates having a local SNR below the threshold and retaining any defect candidates having a local SNR above the threshold. In this manner, the output of the nuisance filtering step may be a partial correlation for the defects reported. What a partial correlation for the defects reported means in this context is that the local SNR test does not need to pass on every test image (i.e., every first and/or second image and/or every first and/or second difference image) for a defect to be reported. At least some of the test images have to pass the local SNR test to be considered a repeater defect, and how many of the test images have to pass to be considered a repeater defect is controlled by the repeater threshold. The repeater threshold may be set in advance by a user or in another suitable manner and may vary depending on a number of variables such as the level of process variation expected across the specimen, which may cause a defect to repeat in fewer than all of the test images and/or may cause noise in the test images that can be erroneously detected as defects. Therefore, even if a defect does not repeat at every instance of a test image, under the right circumstances, it may be appropriate to consider it a repeater defect.

The final repeater defect candidates (i.e., defects that repeat in numbers greater than the repeater threshold) may all be identified as defects on the reticle. However, identifying the defects on the reticle based on the final repeater defect candidates may optionally include some additional analysis. For example, the repeaters may be input to any suitable post-processing known in the art such as defect classification (e.g., via any suitable defect classification method or algorithm). Repeater analysis may also include sampling defects for review, which may be performed on a subset of all of the final repeater defect candidates to verify and/or classify the sampled defects. Such review sampling may generate review samples that include information for the selected subset of the final repeater defect candidates, which can then be sent to a defect review tool (not shown) that performs the defect review.

In some instances, the defects will not be reported in reticle coordinates by the computer subsystem. In other words, when the computer subsystem detects a defect, the coordinates of the location of that defect may not be determined by the computer subsystem with respect to a reticle. The coordinates of the defects determined by the computer subsystem may be translated into reticle coordinates by the computer subsystem or another system or method. The coordinates may be translated in a number of different ways. For example, one relatively straightforward way is to translate the coordinates reported for the defects to a reference that is common to the specimen and the reticle such as a design for the specimen and the reticle. In one such example, the images generated for the defects by the inspection subsystem can be aligned to the design for the specimen. Once the design coordinates of the defects are determined, those coordinates can be translated to reticle coordinates based on the known relationship between the design and the reticle.

The computer subsystem may preferably store information for all of the detected defects such that the information for all of the detected defects is available for RDD and any other functions. Once RDD is performed by the computer subsystem, the information that was stored for defects determined to not be reticle and/or die repeaters may be eliminated from the stored information prior to sending that information to another computer subsystem, another method, back to storage, etc.

The computer subsystem may be configured for storing results of any one or more steps described herein in a computer-readable storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. For example, the defects detected on the reticle may be used to control and/or alter a reticle repair or cleaning process in which the goal is to remove or repair one or more reticle defects to thereby prevent such reticle defects from being printed on other specimens.

In one such example, information for the defects detected on the reticle may be used by the computer subsystem described herein, another system (e.g., a reticle repair system (not shown), which may or may not be part of or coupled to the system embodiments described herein), or another method (e.g., a reticle repair method) to determine where on a reticle a repair or cleaning process should be performed. The information for the defects detected on the reticle may also be used to determine one or more parameters of such a process such as the area on which the process is to be performed, the length of time that the process is to be performed, which chemicals or gases should be used in the process, etc. The determined one or more parameters can then be used by the reticle repair system or method to perform the reticle repair process on the reticle. The reticle repair process may then alter the reticle to repair or remove any defects that were determined to cause defects on the specimen printed with the reticle. In this manner, the altered reticle can be used to print other specimens in the lithography process. The altered reticle may also be re-inspected using the embodiments described herein at another time after it has been re-introduced to the lithography process.

Another embodiment relates to another system configured to detect defects on a reticle. This system includes an inspection subsystem configured as described above. The system also includes a computer subsystem, e.g., computer subsystem(s) 100, configured for generating first and second stacked difference images as described above. For example, in one embodiment, generating the first stacked difference image includes generating first difference images for the multiple instances of the patterned area and combining at least a portion of the first difference images, and generating the second stacked difference image includes generating second difference images for the multiple instances of the patterned area and combining at least a portion of the second difference images. In one such embodiment, generating the first difference images includes separately subtracting a first reference from the first images, and generating the second difference images includes separately subtracting a second reference from the second images. These steps may be performed as described further herein.

In another embodiment, the computer subsystem is configured for generating third and fourth stacked difference images for the multiple instances of the patterned area based on the first and second images, respectively, generated for the multiple instances of the patterned area, the first and third stacked difference images are generated with different references for the first images, and the second and fourth stacked difference images are generated with different references for the second images. For example, a difference image is generated by subtracting a reference image from a test image. Two difference images may be computed for each inspected frame and each mode. The two difference images generated for each inspected frame and mode may be computed by splitting the possible reference images for that frame into two sets. The first set may then be used to generate one difference image for one frame and a first mode, and the second set may be used to generate another difference image for the one frame and the first mode. These steps may also be performed for other frames and the first mode and the frames and the other mode. The stacked difference images then are the average of the frame difference images. For a single mode, there are two difference images per frame, and those two difference images may be used to generate two stacked difference images per mode, i.e., the first and third stacked difference images for the first mode and the second and fourth stacked difference images for the second mode. In other words, “Mode 1 Stacked Diff 1” may be the first stacked difference image for mode 1, and “Mode 1 Stacked Diff 2” may be the second stacked difference image for mode 1. “Mode 2 Stacked Diff 1” may be the first stacked difference image for mode 2, and “Mode 2 Stacked Diff 2” may be the second stacked difference image for mode 2.

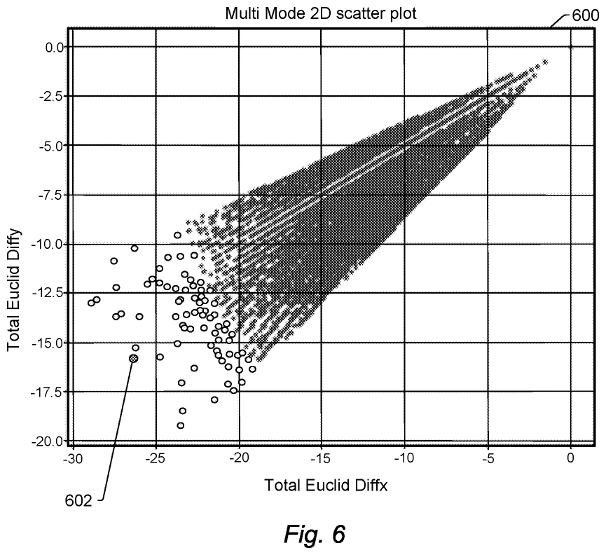

The computer subsystem is also configured for generating a 2D scatter plot of second values in the second stacked difference images as a function of first values in the first stacked difference images corresponding to substantially the same locations in the multiple instances of the patterned area. The embodiments described herein therefore provide another new method for multi-mode detection. This approach also takes advantage of two imaging modes used to inspect the specimen through multi-mode detection. In particular, instead of generating a 2D scatter plot for each individual mode for defect detection, a new kind of 2D scatter plot can be built with the x-axis for the difference of a first mode and the y-axis for the difference of a second mode, as shown by multi-mode 2D scatter plot 600 in FIG. 6. In this manner, the 2D scatter plot generated by the embodiments described herein may be referred to as a multi-mode 2D scatter plot.

“Substantially the same locations” as that term is used herein is generally defined as locations in the multiple instances of the patterned areas that are identified as the same in the images used in the embodiments described herein via some alignment between the multiple images generated for the multiple instances of the patterned area. Therefore, locations that are substantially the same, as that term is used herein, may not be exactly the same, but the same to within the accuracy of the alignment method used to align the images. For example, the different images used in the embodiments described herein may be aligned to a common reference by any suitable alignment method known in the art and then corresponding locations in the different images (locations having the same spatial relationship to the common reference) may be identified as substantially the same for the purposes described herein.

In one embodiment, the computer subsystem is configured for generating the 2D scatter plot of the second values and fourth values in the second and fourth stacked difference images, respectively, as a function of the first values and third values in the first and third stacked difference images, respectively, corresponding to substantially the same locations in the multiple instances of the patterned area. For example, in 2D scatter plot 600 shown in FIG. 6, values for (Mode 2 Stacked Diff 1+Mode 2 Stacked Diff 2) may be plotted on the y axis, and values for (Mode 1 Stacked Diff 1+Mode 1 Stacked Diff 2) may be plotted on the x axis. If multiple stacked difference images are not generated for each frame and mode, values for (Mode 2 Stacked Diff) may be plotted on the y axis, and values for (Mode 1 Stacked Diff) may be plotted on the x axis. The values of the images used to generated the 2D scatter plot may include any of the values determined for the images including, but not limited to, SNR.

The computer subsystem is further configured for detecting defect candidates in the multiple instances of the patterned area on the specimen by applying a defect detection method to the 2D scatter plot. Applying a defect detection method to the 2D scatter plot may be performed as described further herein. For example, in one embodiment, detecting the defect candidates includes identifying outliers in the 2D scatter plot. While the shape of the 2D scatter plot generated for multiple modes may be substantially different (as shown in FIG. 6) compared to other 2D scatter plots (such as those shown in FIG. 5), the outliers may be identified in a similar manner in the multi-mode 2D scatter plot.

In one embodiment, the detected defect candidates include a DOI that is not detectable in the first and second images and the first and second stacked difference images. For example, a signal from a DOI buried inside a noise cloud of a 2D scatter plot generated for only a single mode may become an outlier when a multi-mode 2D scatter plot is generated as described herein. In this manner, a DOI that is not detectable with individual modes may be detected by multi-mode 2D scatter plot generation. For example, data point 602 shown in FIG. 6 may be a DOI that is detectable with a multi-mode 2D scatter plot, but is not detectable in a 2D scatter plot (not shown) generated from a stacked difference image generated for the first or second modes described herein. In this manner, FIG. 6 illustrates a multi-mode 2D scatter plot of a challenging DOI detectable through multi-mode detection but missed by individual modes. These multi-mode 2D scatter plot based embodiments are therefore particularly advantageous for detection of relatively weak signal repeater defects that individual modes cannot detect.

The embodiments described herein may also be advantageously configured for detecting relatively weak signal repeater defects by performing defect detection with a multi-mode 2D scatter plot, and each mode may be configured to, in combination, detect specific types of defects that are not detectable by other individual modes singly. For example, the modes used in the embodiments described herein may be selected to be complementary to each other. One of the modes may be particularly suited for detecting a first type of DOI but not a second type of DOI, while another of the modes may be particularly suited for detecting the second type of DOI and not the first. In this manner, the combination of modes may detect more DOI types than either of the modes individually. Using such modes in the embodiments described herein is therefore advantageous for these reasons and other reasons described herein.

In some embodiments, the detected defect candidates are farther outside of a noise cloud in the 2D scatter plot than a different noise cloud in a different 2D scatter plot generated from only the first stacked difference images or generated from only the second stacked difference images. For example, as described above, a signal from a DOI may be buried inside of a noise cloud of a 2D scatter plot generated from only single mode images of the specimen. That same DOI may however have a signal that is outside of the noise cloud in a 2D scatter plot generated as described herein from multiple mode images, used to generate the first and second stacked difference images. In addition, signals for DOIs that are not buried inside of a noise cloud of a single mode 2D scatter plot may be located even farther outside of a noise cloud of a multi-mode 2D scatter plot since as described herein, the embodiments suppress noise in the images used for defect detection. Increasing the separability between a DOI signal and noise and/or nuisances is advantageous as described further herein.

In a further embodiment, the defect detection method determines that a defect candidate is present at a location in the multiple instances of the patterned area only when the defect detection method detects the defect candidate in the 2D scatter plot. In other words, the defect detection method is not applied to the individual difference images or the images themselves. Instead, the only input to the defect detection method or algorithm may be the stacked difference images and/or the multi-mode 2D scatter plot generated therefrom. Using only the stacked difference images generated for multiple modes as the input to the defect detection method may be advantageous (even if the other images described herein are available as inputs to the defect detection method) since the multi-mode 2D scatter plot generated from the stacked difference images will have less noise than each of the other images and a higher SNR for any DOIs present in the images. Therefore, other images described herein will generally provide no information, signals, etc. that can enhance defect detection performed with only the stacked difference images and the multi-mode 2D scatter plot generated therefrom. Other information described herein, like reference images, design information, CA information, etc., may however also be input to the defect detection method with the stacked difference images for the multiple modes and/the multi-mode 2D scatter plot.

The computer subsystem is also configured for identifying defects on the reticle based on the detected defect candidates. Identifying the defects on the reticle based on the detected defect candidates may be performed as described further herein. In one embodiment, the defects identified on the reticle include at least one defect on the reticle that prints in two or more of the multiple instances of the patterned area on the specimen. For example, as described herein, the embodiments preferably detect and identify repeating defects on the specimen that are caused by defects on the reticle. These defects may be detected and identified as described further herein.

The embodiments described herein have, therefore, a number of advantages over currently used methods and systems for detecting defects on reticles. For example, mask repeater defects cause yield loss on every reticle printed if not detected. With shrinking design rules, repeater defect size that should not be missed is getting smaller. Signals for smaller repeater sizes also get weaker which requires ways to achieve better noise reduction and better nuisance suppression to minimize defect review load. The embodiments described herein provide solutions for detecting such defects easily and cost effectively.

These and other advantages described herein are enabled by a number of important new features of the embodiments described herein. One such new feature is reducing specimen noise by averaging difference images generated with different modes and performing detection on averaged difference images while currently used methods perform detection on difference images generated with only a single mode. As noise is reduced via the averaging of the multi-mode difference images, defect signals stand farther out of the noise cloud of 2D scatter plots, and relatively small/relatively weak repeater and random defects can be detected. In addition, the embodiments described herein enable relatively weak signal repeater DOI detection through a multi-mode 2D scatter plot versus individual modes separately where relatively weak signals from DOIs may be buried deep inside individual mode 2D scatter plot noise clouds.

Each of the embodiments of the system described herein may be combined with any other embodiments of the system described herein.

Another embodiment relates to a computer-implemented method for detecting defects on a reticle. The method includes acquiring first and second images for a specimen generated with first and second modes, respectively, of an inspection subsystem. A reticle is used to print multiple instances of a patterned area on the specimen in a lithography process. The method also includes generating first and second stacked difference images for the multiple instances of the patterned area based on the first and second images, respectively, generated for the multiple instances of the patterned area.

In one embodiment, the method includes averaging the first and second stacked difference images to thereby generate an averaged stacked difference image. The method also includes detecting defect candidates in the multiple instances of the patterned area on the specimen by applying a defect detection method to the averaged stacked difference image. The method further includes identifying defects on the reticle based on the detected defect candidates.

In another embodiment, the method includes generating a 2D scatter plot of second values in the second stacked difference images as a function of first values in the first stacked difference images corresponding to substantially the same locations in the multiple instances of the patterned area. The method also includes detecting defect candidates in the multiple instances of the patterned area on the specimen by applying a defect detection method to the 2D scatter plot. In addition, the method includes identifying defects on the reticle based on the detected defect candidates.

Each of the steps of the methods are performed by a computer subsystem coupled to the inspection subsystem, both of which may be configured according to any of the embodiments described herein. Each of the steps of the methods may be performed as described further herein. The methods may also include any other step(s) that can be performed by the inspection subsystem and/or computer subsystem described herein. In addition, the methods described above may be performed by any of the system embodiments described herein.

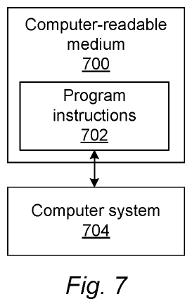

An additional embodiment relates to a non-transitory computer-readable medium storing program instructions executed on a computer system for performing a computer-implemented method for detecting defects on a reticle. One such embodiment is shown in FIG. 7. In particular, as shown in FIG. 7, non-transitory computer-readable medium 700 includes program instructions 702 executable on computer system 704. The computer-implemented method may include any step(s) of any method(s) described herein.

Program instructions 702 implementing methods such as those described herein may be stored on computer-readable medium 700. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 704 may be configured according to any of the embodiments described herein.

Further modifications and alternative embodiments of various aspects of the invention will be apparent to those skilled in the art in view of this description. For example, systems and methods for detecting defects on a reticle are provided. Accordingly, this description is to be construed as illustrative only and for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured to detect defects on a reticle, comprising:
an inspection subsystem configured to generate first and second images for a specimen with first and second modes, respectively, of the inspection subsystem, wherein a reticle is used to print multiple instances of a patterned area on the specimen in a lithography process; and
a computer subsystem configured for:
generating first and second stacked difference images for the multiple instances of the patterned area based on the first and second images, respectively, generated for the multiple instances of the patterned area;
averaging the first and second stacked difference images to thereby generate an averaged stacked difference image;
detecting defect candidates in the multiple instances of the patterned area on the specimen by applying a defect detection method to the averaged stacked difference image; and
identifying defects on the reticle based on the detected defect candidates.

2. The system of claim 1, wherein generating the first stacked difference image comprises generating first difference images for the multiple instances of the patterned area and combining at least a portion of the first difference images, and wherein generating the second stacked difference image comprises generating second difference images for the multiple instances of the patterned area and combining at least a portion of the second difference images.

3. The system of claim 2, wherein generating the first difference images comprises separately subtracting a first reference from the first images, and wherein generating the second difference images comprises separately subtracting a second reference from the second images.

4. The system of claim 1, wherein the defect detection method determines that a defect candidate is present at a location in the multiple instances of the patterned area only when the defect detection method detects the defect candidate at the location in the averaged stacked difference image.

5. The system of claim 1, wherein noise in the first and second stacked difference images is not correlated.

6. The system of claim 1, wherein noise in the averaged stacked difference image is suppressed compared to the noise in the first and second stacked difference images.

7. The system of claim 1, wherein a signal corresponding to at least one of the defect candidates in the first and second stacked difference images is correlated.

8. The system of claim 1, wherein the defect candidates have a higher signal-to-noise ratio in the averaged stacked difference image than in the first and second stacked difference images.

9. The system of claim 1, wherein the detected defect candidates comprise a defect of interest that is not detectable in the first and second images and the first and second stacked difference images.

10. The system of claim 1, wherein the defects identified on the reticle comprise at least one defect on the reticle that prints in two or more of the multiple instances of the patterned area on the specimen.

11. A system configured to detect defects on a reticle, comprising:
an inspection subsystem configured to generate first and second images for a specimen with first and second modes, respectively, of the inspection subsystem, wherein a reticle is used to print multiple instances of a patterned area on the specimen in a lithography process; and
a computer subsystem configured for:
generating first and second stacked difference images for the multiple instances of the patterned area based on the first and second images, respectively, generated for the multiple instances of the patterned area;
generating a two-dimensional scatter plot of second values in the second stacked difference images as a function of first values in the first stacked difference images corresponding to substantially the same locations in the multiple instances of the patterned area;
detecting defect candidates in the multiple instances of the patterned area on the specimen by applying a defect detection method to the two-dimensional scatter plot; and
identifying defects on the reticle based on the detected defect candidates.

12. The system of claim 11, wherein generating the first stacked difference image comprises generating first difference images for the multiple instances of the patterned area and combining at least a portion of the first difference images, and wherein generating the second stacked difference image comprises generating second difference images for the multiple instances of the patterned area and combining at least a portion of the second difference images.

13. The system of claim 12, wherein generating the first difference images comprises separately subtracting a first reference from the first images, and wherein generating the second difference images comprises separately subtracting a second reference from the second images.

14. The system of claim 11, wherein the computer subsystem is further configured for generating third and fourth stacked difference images for the multiple instances of the patterned area based on the first and second images, respectively, generated for the multiple instances of the patterned area, wherein the first and third stacked difference images are generated with different references for the first images, and wherein the second and fourth stacked difference images are generated with different references for the second images.

15. The system of claim 14, wherein the computer subsystem is further configured for generating the two-dimensional scatter plot of the second values and fourth values in the second and fourth stacked difference images, respectively, as a function of the first values and third values in the first and third stacked difference images, respectively, corresponding to substantially the same locations in the multiple instances of the patterned area.

16. The system of claim 11, wherein the detected defect candidates comprise a defect of interest that is not detectable in the first and second images and the first and second stacked difference images.

17. The system of claim 11, wherein detecting the defect candidates comprises identifying outliers in the two-dimensional scatter plot.

18. The system of claim 11, wherein the detected defect candidates are farther outside of a noise cloud in the two-dimensional scatter plot than a different noise cloud in a different two-dimensional scatter plot generated from only the first stacked difference images or generated from only the second stacked difference images.

19. The system of claim 11, wherein the defects identified on the reticle comprise at least one defect on the reticle that prints in two or more of the multiple instances of the patterned area on the specimen.

20. The system of claim 11, wherein the defect detection method determines that a defect candidate is present at a location in the multiple instances of the patterned area only when the defect detection method detects the defect candidate in the two-dimensional scatter plot.
